(19) United States
(12) Patent Application Publication
(10) Pub. No.: US 2003/0016122 A1
(43) Pub. Date: Jan. 23, 2003

(54) Patient wristband form with built in RFID

(76) Inventor: Kathryn D. Petrick, Minneapolis, MN (US)

Correspondence Address: NIXON & VANDERHYE P.C., 8th Floor, 1100 North Glebe Rd., Arlington, VA, 22201-4714, US

(21) Appl. No.: 09/907,737

(22) Filed: Jul. 19, 2001

(51) Int. Cl. H04Q 5/22

(52) U.S. Cl. 340/10.41; 340/825.49

(57) ABSTRACT

An apparatus for identifying and providing information relating to a patient in a healthcare facility comprises a wristband worn by the patient and a radio frequency identification (RFID) transponder coupled to the wristband. The transponder is capable of automatically and periodically generating and transmitting a first signal encoding the identity and location of the patient to an RF receiver, and generating and transmitting a second signal encoding the identity and the medical records of the patient to an RFID reader in response to receiving an interrogation signal from the reader. The reader may be operatively coupled to a device for providing medical treatment or diagnosis.

### BACKGROUND OF THE INVENTION

1. Field of the Invention

The present invention relates to a radio frequency identification (RFID) system for managing a healthcare facility. More specifically, the present invention relates to an RFID system in which RFID receivers obtain and process signals from a RFID transponder coupled to a patient wristband and/or from an RFID transponder mounted on an asset of the healthcare facility.

2. Background of Related Art

Wristbands are often worn by patients in a healthcare facility to provide, at the very least, identification information. This identification information may be explicitly spelled out on the patient wristband. Additionally or alternatively, a bar code may be printed on the patient wristband. By scanning the bar code with an appropriate reader, additional information such as the patient's medical records can be retrieved from a database. The patient's medial records include, for example, information relating to patient treatment and medication administration.

Patient wristbands having radio frequency or infrared circuitry including an integrated circuit (IC) chip for storing data are known. For example, U.S. Pat. No. 5,973,600 to Mosher, Jr (1999) and U.S. Pat. No. 5,883,576 to De La Huerga (1999) disclose patient wristbands of this type.

The wristbands are typically worn by a patient from the time he/she is admitted to a healthcare facility until the time he/she exits the facility. During the patient's stay, it may be necessary to track the location of the patient to, for example, assist the patient from becoming lost within the facility. This will be particularly helpful if the facility is large. It would therefore be beneficial to provide a way to track the patient's location within the facility and to do so using the same wristband which includes an IC chip for storing medical records of the patient. This would help maximize patient comfort during his/her stay be avoiding the need for multiple devices to be worn.

### SUMMARY OF THE INVENTION

In an exemplary embodiment of the present invention, an apparatus for identifying and providing information relating to a person comprises a wristband capable of being worn by the person and a radio frequency identification (RFID) transponder coupled to the wristband. The transponder is capable of automatically and periodically generating and transmitting a first set of signals each signal encoding the identity and current location of the person wearing the wristband. The transponder is also capable of generating and transmitting a second signal encoding at least the identity of the person wearing the wristband in response to receiving an interrogation signal. The second signal may also encode medical records of the person wearing the wristband such as patient diagnosis/treatment and medication administration records.

In another exemplary embodiment of the invention, a radio frequency identification (RFID) system comprises an RFID reader for transmitting an interrogation signal and receiving a response signal in response to the interrogation signal, an rf receiver for receiving rf signals, a data processing and control system operatively coupled to the RFID reader and the rf receiver, and an RFID transponder for receiving the interrogation signal from the RFID reader and generating and transmitting the response signal, and for automatically and periodically generating and transmitting rf signals for reception by the rf receiver. The response signal transmitted by the transponder may encode at least identification information and the rf signals automatically generated and transmitted by the transponder may encode identification and location information. The RFID transponder may be coupled to a wristband capable of being worn by a person. In some embodiments, the response signal transmitted by the transponder encodes the identity and medical records of the person wearing the wristband and each of the rf signals automatically generated and transmitted by the transponder respectively encodes an identity and location of the person wearing the wristband. The data processing and control system updates medical records based on the response signal and updates data relating to the location of the person based on the rf signals. The data processing and control system may also update automatically accounting records associated with the person identified in the response signal. The RFID reader may be operatively coupled to a device for providing a medical diagnosis or treatment and a second rf transponder may be attached to the device for automatically generating and transmitting rf signals which indicate the location of the device.

In yet another exemplary embodiment of the present invention, an apparatus comprises a device, an RFID reader for transmitting an interrogation signal and receiving a response signal in response to the interrogation signal, and an RFID transponder for automatically and periodically generating and transmitting rf signals each of which indicates the location of the device. The reader is operatively coupled to the device and the second transponder is attached to the device. The device may provide a medical treatment or diagnosis and the response signal received by the reader may encode patient identity and medical record information. The reader may be operatively coupled to a data processing and control system for processing patient identity and medical record information based on the response signal, and for automatically updating accounting records associated with the patient identity.

### BRIEF DESCRIPTION OF THE DRAWINGS

These, as well as other objects and advantages of this invention, will be more completely understood and appreciated by careful study of the following more detailed description of the presently preferred exemplary embodiments of the invention taken in conjunction with the accompanying drawings, in which:

FIGS. 1A-1D illustrate a method of constructing a patient wristband in accordance with an exemplary embodiment of the present invention;

FIG. 2 is a diagram illustrating an RFID system in accordance with an exemplary embodiment of the present invention;

FIG. 3 is a diagram illustrating an RFID system in accordance with another exemplary embodiment of the present invention; and

FIG. 4 is a diagram illustrating an RFID system in accordance with yet another exemplary embodiment of the present invention.

### DETAILED DESCRIPTION OF THE INVENTION

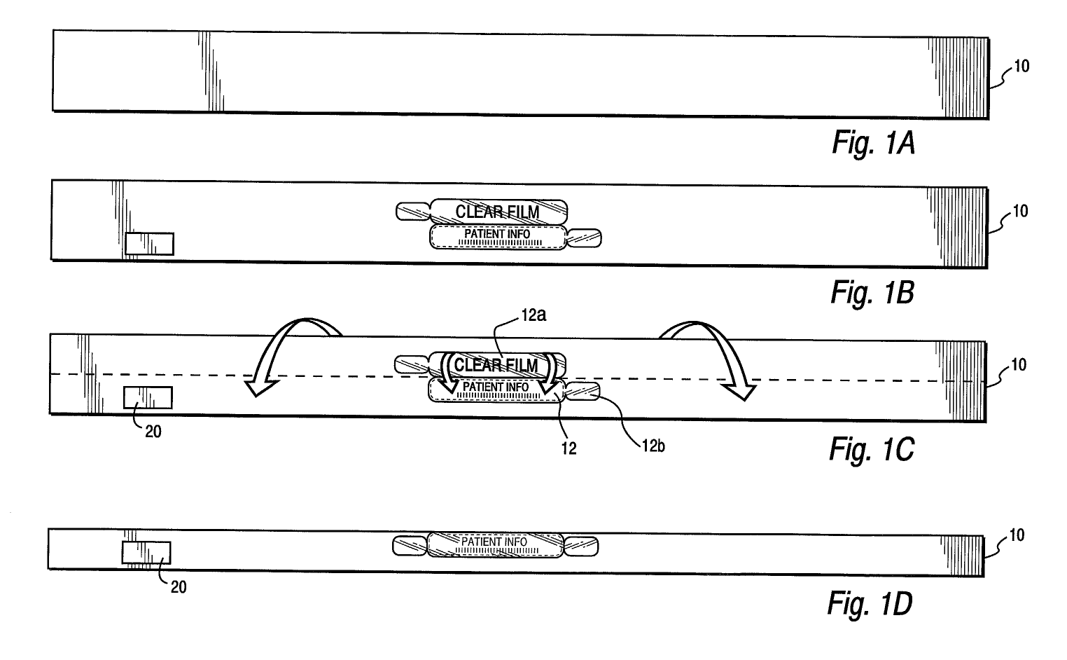

FIGS. 1A-1D illustrate the construction of a wristband 10 in accordance with an exemplary embodiment of the present invention. The wristband 10 may be worn, for example, by a patient in a healthcare facility by wrapping the ends of the wristband 10 around the patient's wrist and securing its ends together. The wristband includes a label 12 and a radio frequency identification (RFID) transponder 20. One portion 12a of the label 12 is made of a clear film and another portion 12b of the label 12 contains printed information such as the patient's name and/or a bar code.

As illustrated in FIG. 1B, the label 12 and the transponder 20 are placed on one side of a self-laminating band. The portion 12a of the label 12 is arranged on the top half of the band and the second portion 12b of the label 12 is arranged on the bottom half of the band.

As illustrated in FIG. 1C, the top half of the self-laminating band is folded along an imaginary bisecting axis extending along the length of the band (illustrated by the longitudinal dashed line in FIG. 1C) to join the bottom half of the band. The first portion 12a of the label 12 is therefore folded over the second portion 12b. Since the first portion 12a is formed by a clear film, the information printed on the second portion 12b is visible through the first portion 12a (see FIG. 1D). A bar code reader (not shown) may thus successfully scan any bar code printed on the second portion 12b. The transponder 20 is enclosed within the top half of the band and the bottom half of the band. Alternatively, the transponder 20 may be secured to an outside layer of the wristband 10, rather than being enclosed within the wristband 10.

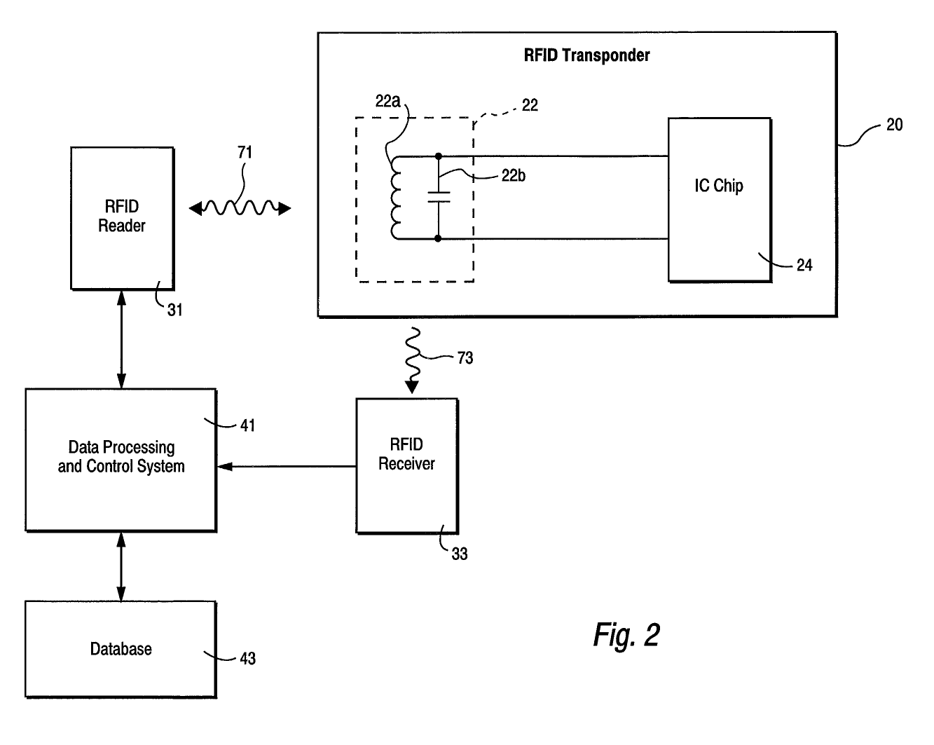

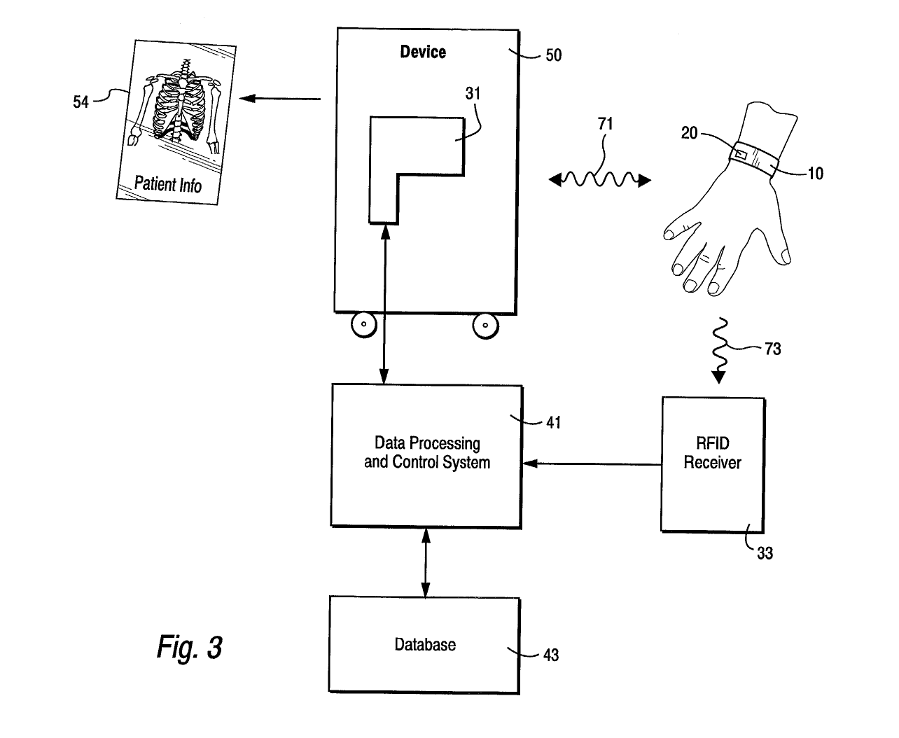

FIGS. 2-3 illustrate an RFID system in accordance with an exemplary embodiment of the present invention. The RFID system includes the transponder 20, an RFID reader 31, an RFID receiver 33, a data processing and control system 41 and a database 43. The transponder 20 is capable of communicating with the RFID reader 31 (illustrated by two-way arrow 71) and capable of generating and transmitting signals to the RFID receiver 33 (illustrated by one-way arrow 73). Both the RFID reader 31 and the RFID receiver 33 are operatively connected to the data processing and control system 41. Data processed by the system 41 may be provided to, stored by and/or received from the database 43.

The transponder 20 comprises an rf inlay formed by an antenna 22 and an IC chip 24. The antenna 22 includes an inherent inductance 22a and capacitance 22b which in part define the resonant frequency of the transponder 20. The IC chip 24 includes an internal battery, circuitry and logic for processing signals received through the antenna 22 and generating and providing signals to the antenna 22 for transmission, and a storage memory (not shown).

Using power provided by the internal battery, the transponder 20 generates and transmits a beacon signal (represented by reference label 73) from antenna 22. That is, the transponder 20 automatically and periodically generates and transmits a plurality of signals. Each signal contains encoded information that indicates the identity of the patient wearing the wristband 10 and the location of the patient at the time that the signal is transmitted. It is thus possible to effectively track the location of a patient during his/her stay in the healthcare facility. A patient can therefore be assisted if he/she becomes lost within the facility. The delay between each repeated transmission of the beacon signal is set depending on how frequently it is deemed necessary to receive an update on the patient's location.

The beacon signal indicating the patient's identity and location is received by an RFID receiver 33 and provided to the data processing and control system 41. The data processing and control system 41 decodes the identity and location information encoded on the signal and stores this data is in the database 43.

In addition to automatically generating and transmitting the beacon signal to RFID receiver 33, the transponder 20 can conduct communication (represented by reference number 71) with an RFID reader 31. The transmission of the beacon signal is disabled if the transponder 20 is conducting communication with the RFID reader 31 at the time the transponder is scheduled to transmit the beacon signal. Any potential errors caused by interfering transmissions may therefore be avoided.

The communication between the transponder 20 and the reader 31 is initiated once the transponder 20 successfully receives an interrogation signal transmitted by the reader 31. This may only occur if the transponder is within the transmission range of the interrogation signal. Once the transponder 20 successively receives the interrogation signal, the circuitry and logic stored on the IC chip 24 decodes the interrogation signal and transmits a response signal to the reader 32. The response signal may encode any of the information stored in the storage memory of the IC chip 24. This information may include, for example, identity and medical records of the patient.

After being received by the reader 31, the data processor and control system 41 decodes and processes the response signal. The information encoded by the response signal can then be displayed to personnel of the healthcare facility, used to update previous records and/or stored in the database 43. Additionally, the information provided by the response signal can be used by the data processing and control system 41 to automatically update other records such as accounting records for charging the patient, or provided to another processing system such as that of a medical insurance company.

Assuming that communication between the transponder 20 and the reader 31 is still established, the communication may involve information being transmitted from the reader 31 to the transponder 20. Specifically, information relating to the patient's treatment, diagnosis, health, medical records etc. can transmitted from the reader 31 to the antenna 22 of the transponder 20 and decoded and stored by the IC chip 24. By transmitting data between the transponder 20 and reader 31 and storing data is the database 43 and/or IC chip 24, the amount of paperwork and the physical space needed to store the paperwork may be reduced, re-entry of data can be minimized, current records can be easily accessed, and data and medical treatment administration errors can be minimized.

As illustrated in FIG. 3, reader 31 may be operatively connected to a device 50 for providing a medical diagnosis or medical treatment. These devices may include, for example, portable x-ray machines or IV pumps. After the reader 31 transmits an interrogation signal and receives a response signal from the transponder 20, the information encoded on the response signal may be used to disable the device if, for example, the identity of the patient indicated by the response signal does not match the intended patient indicated by the device. Alternatively, the information encoded by the response signal such as identity information can automatically be used to print an identification label on an output of the device such as printing patient identification information at the bottom on an x-ray 54 or the like. Once the service provided by the medical device 50 is completed, data can be provided from the reader 31 to the data processing and control system 41 reflecting the service so that the patient's account can automatically be charged. Lost billings of the facility may thus be minimized.

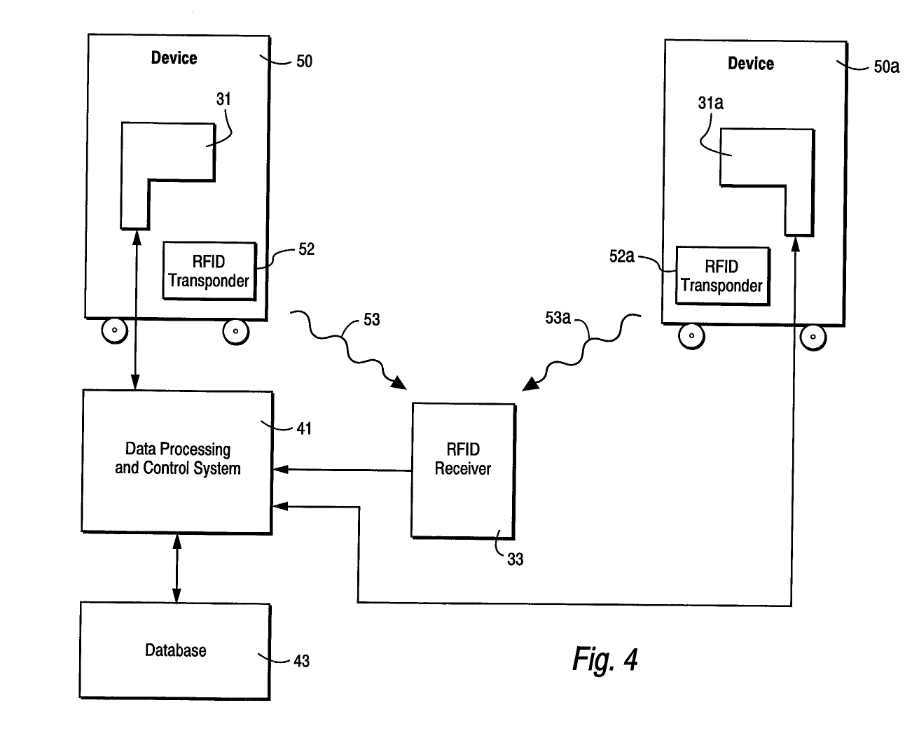

As illustrated in FIG. 4, an RFID transponder 52 may be attached to the device 50. The device 50 having the RFID transponder 52 may or may not also have the RFID reader 31. If the device 50 is made of a metal, the transponder 52 must be suitably spaced and/or shielded from the metal. The transponder 52 transmits a beacon signal (illustrated by one-way arrow 53) in same manner described above for the transponder 20. Like device 50, device 50a may also have an RFID reader 31 a and a RFID transponder 52a. The transponders 52, 52a respectively produce beacon signals 53, 53a to indicate the identity and location of each device 50, 50a. The signals 53, 53a are received by the receiver 33 (or by a different receiver), decoded and processed by the system 41 and stored in database 43. By tracking the locations of the various devices, the assets of the healthcare facility may be effectively managed and efficiently used.

While the above exemplary embodiments discuss the use of an RFID system to manage data in a healthcare facility, those skilled in the art will appreciate that the present invention may used in virtually any environment in which RFID systems are effective such as warehouses, stores, etc.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. An apparatus for identifying and providing information relating to a person, the apparatus comprising:
a wristband capable of being worn by the person;
a radio frequency identification (RFID) transponder coupled to the wristband, the transponder being capable of automatically and periodically generating and transmitting a first signal encoding the identity and location of the person wearing the wristband, and for generating and transmitting a second signal encoding at least the identity of the person wearing the wristband in response to receiving an interrogation signal.

2. An apparatus of claim 1 wherein the second signal also encodes medical records of the person wearing the wristband.

3. A radio frequency identification (RFID) system comprising:
an RFID reader for transmitting an interrogation signal and receiving a response signal in response to the interrogation signal;
an rf receiver for receiving rf signals;
a data processing and control system operatively coupled to the RFID reader and the rf receiver; and
an RFID transponder for receiving the interrogation signal from the RFID reader and generating and transmitting the response signal, and for automatically and periodically generating and transmitting rf signals for reception by the rf receiver.

4. A system of claim 3 wherein the response signal transmitted by the transponder encodes at least identification information and the rf signals automatically generated and transmitted by the transponder encodes identification and location information.

5. A system of claim 3 wherein the RFID transponder is coupled to a wristband capable of being worn by a person.

6. A system of claim 5 wherein the response signal transmitted by the transponder encodes the identity and medical records of the person wearing the wristband and the rf signals automatically generated and transmitted by the transponder encodes an identity and location of the person wearing the wristband.

7. A system of 6 wherein the data processing and control system updates the medical records of the person based on the response signal and updates the location of the person based on the rf signals.

8. A system of claim 6 wherein the data processing and control system updates the medical records of the person based on the response signal and automatically updates accounting records relating to the person.

9. A system of claim 3 wherein the RFID reader is operatively coupled to a device for providing a medical diagnosis or treatment and a second rf transponder is attached to the device for automatically generating and transmitting rf signals which indicate location of the device.

10. An apparatus comprising:
a device;
an RFID reader for transmitting an interrogation signal and receiving a response signal in response to the interrogation signal, the reader being operatively coupled to the device; and
an RFID transponder for automatically and periodically generating and transmitting rf signals each of which indicates the location of the device, the transponder being attached to the device.

11. An apparatus of claim 10 wherein the device provides a medical treatment or diagnosis and the response signal received by the reader encodes patient identity and medical record information.

12. An apparatus of claim 11 the reader is operatively coupled to a data processing and control system for processing patient identity and medical record information based on the response signal and automatically updating accounting records associated with the patient identity.
